(19) United States
(12) Patent Application Publication
(10) Pub. No.: US 2009/0049556 A1
(43) Pub. Date: Feb. 19, 2009

(54) METHOD FOR REDISTRIBUTING DRM PROTECTED CONTENT

(75) Inventors: Koen Hendrik Johan Vrielink, Eindhoven (NL); Erwin Kragt, Eindhoven (NL); Wilhelmus Josephus Herman Jan Bronnenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/279,866

(22) PCT Filed: Feb. 15, 2007
(86) PCT No.: PCT/IB07/50496

§ 371 Date: Aug. 19, 2008

(30) Foreign Application Priority Data
Feb. 22, 2006 (EP) 06110252.1

(51) Int. Cl. G06F 21/00

(52) U.S. Cl. 726/26

(57) ABSTRACT

The present invention relates to a method and a device (207) for providing a party (214) with a content item license (202). A basic idea of the present invention is to enable redistribution of, or giving away/gifting of, digital content items while satisfying DRM requirements. Hence, determining means in the form of e.g. a proximity verifier receives authentication data of a first party (213) wishing to give away or redistribute a content item (215). The proximity verifier also receives authentication data of a second party (214) to which the content item is to be transferred. Further, a license (202) associated with the content item and the first party is received at the proximity verifier (207) from the first party. The license may be associated with the first party and the content item by a first party identifier (203) and a content item identifier (204) comprised in the license. The proximity verifier determines whether the first party and the second party are in physical proximity to each other. If that is the case, the verifier creates a new license (212) associated with said content item (215) as well as with the second party (214), and revoking the license (202) associated with the first party (213).

The present invention relates to a method and a device for providing a party with a content item license.

Recent developments in digital technologies, along with increasingly interconnected high-speed networks and decreasing prices for high-performance digital devices, have established digital content distribution as one of the most rapidly emerging trading activities and have created new methods for consumers to access, manage, distribute and pay for digital content. As a consequence of this trend and the success of one of the first online music shops—Apple's iTunes, a number of shops have been opened and both consumers and content providers have clearly shown high interest in electronic distribution of audio/video content.

The rapid spread of digital information has given rise to the concept of digital rights management (DRM). This concept is used to protect the rights of a creator of digital content, as well as the rights of an information provider distributing the information or content. This concept is applicable to information distributed via any type of media, such as the Internet, a CD, a DVD or the like. It is also applicable to any type of digital information, for example digital audio, video, text etc. DRM technologies are thus used to protect copyrighted content from being used and/or distributed without permission.

A second hand market exists for second hand content stored on media carriers such as CD and or DVD. It is possible to walk into a second hand record shop and trade your CD or vinyl audio carrier for another audio carrier. When trading second hand audio or video that is not associated with a media carrier, the situation is different. The trading of locally generated copies of digital audio is certainly common, but in many cases it is illegal. The trading of copyrighted digital content items via, for example, the Internet is not encouraged by the music or film industry. Content providers try to prevent the unauthorized transfer of digital content from one user to another. As a result, operations relating to the duplication and distribution of digital content are restricted, and sometimes users will try to circumvent the restrictions even though it is illegal.

An important aspect in dealing with digital content is how to manage reselling or redistribution of digital property. In prior art DRM systems, content rights or licenses are associated with content items, such as audio files, movies, electronic books etc. Content rights typically contain rules (e.g. play, copy, distribute etc.) and necessary cryptographic keys for encrypting/decrypting the content item(s) with which they are associated. Content rights should only be transferred to devices that are compliant and operated by users that have appropriate user rights, i.e. rights specifying who can use the content rights. Note that a content right and a user right may be merged in one single license, as is known from Open Mobile Alliance (OMA) DRM. Compliant devices comply with a given standard and adhere to certain operation rules. They also communicate by means of a certain protocol such that they answer questions and requests, which are posed to them, in an expected way. Compliant devices are considered to be trusted, which e.g. means that they will not illegally output content on a digital interface and that ownership of a device is not important.

International application WO2005/101226 (Attorney Docket PHNL040403) entitled “AUTOMATIC BARTERING PROPOSAL FOR CONTENT EXCHANGE”, which is incorporated herein by reference, discloses a method for automatic bartering for items, such as electronic items on the form of e.g. songs, between bartering parties. The method includes exchange of preference data between the parties, computing and exchanging bartering offers and processing the offers. The processing finally results in mutual offer acceptances and possible exchange of items.

International application WO2004/102460 (Attorney Docket PHNL030522) entitled “VALUATING RIGHTS FOR 2^{ND} HAND TRADE”, which is incorporated herein by reference, discloses a method of distributing digital rights, where a trading value of a certain magnitude is attached to a digital right to be distributed. The trading value is determined by a creator of copyrighted digital content associated with the digital right and/or a content provider. The digital right is associated with a digital content bought by a consumer at the provider, and the trading value of the digital right thus specifies the value of the associated digital content when trading the digital content for another digital content. A first content held by a first consumer can be traded for a second content held by a second consumer, the second content having a valid digital right associated to it, on condition that the trading value of the first right meets the trading value of the second right. By means of the trading value, the content provider sanctions the trade of one digital content for another for consumers holding a valid digital right.

A problem related to content item distribution in the prior art is that it does not permit redistribution or giving away/gifting content items in a straightforward manner while ensuring DRM requirements.

An object of the present invention is to solve the above given problems and provide a way for a first party to redistribute a content item to a second party while satisfying certain requirements relating to digital rights management (DRM).

This object is attained by a method of providing a party with a content item license in accordance with claim 1 and a device for providing a party with a content item license in accordance with claim 10.

In a first aspect of the present invention, there is provided a method comprising the steps of receiving authentication data of a first party and a second party, receiving a license associated with a content item and the first party, determining whether the first party and the second party are in physical proximity to each other, creating a license associated with the content item and the second party, if the parties are in physical proximity to each other, wherein the license gives the second party access to the content item, and revoking the license associated with the first party.

In a second aspect of the present invention, there is provided a device comprising deriving means for deriving authentication data of a first party and a second party, receiving means for receiving a license associated with a content item and the first party, determining means for determining whether the first party and the second party are in physical proximity to each other, creating means for creating a license associated with said content item and the second party, if the parties are in physical proximity to each other, wherein the license gives the second party access to the content item, and revoking means for revoking the license associated with the first party.

By requiring physical proximity of both parties, and allowing the gifting of content only upon proof of such proximity, a scenario is created that resembles that of second hand gifting of content on a media carrier, and that as a result of the revocation of the first license does not facilitate unbridled unauthorized copying. Hence, determining means in the form of e.g. a proximity verifier receives authentication data of a first party wishing to give away or redistribute a content item. The proximity verifier also receives authentication data of a second party to which the content item is to be transferred. Further, a license associated with the content item and the first party is received at the proximity verifier from the first party. The license may be associated with the first party and the content item by a first party identifier and a content item identifier comprised in the license.

Preferably the content license is cryptographically protected with a public key of the party with which it is associated. Hence, only the party with which the license is associated can create a clear text copy of the license, by means of using a corresponding private key to decrypt the encrypted license. In DRM systems, to prevent unrestrained distribution of content items, the content items are usually encrypted and the license associated with an encrypted content item then contains a content item decryption key. Consequently, the content item decryption key can only be attained by a party having access to the private key that provides access to a plain text copy of the license. As previously discussed, the content license also typically contains usage rules such as e.g. play, copy, distribute etc, indicating which type of access a party in possession of the license has to the content item. Now, when the proximity verifier attains the encrypted content license, the license must have been encrypted with a key for which the verifier has a corresponding decryption key. As will be shown in the following, this key pair may be chosen in different manners depending on where the verifier physically is arranged. A number of different alternatives are possible for the proximity verifier attainment of the encrypted license. For instance, a first party transfers the encrypted content license to the proximity verifier, the proximity verifier acquires the encrypted licenses on a server, or the proximity verifier may be the device on which encrypted licenses primarily are stored, etc.

The proximity verifier determines whether the first party and the second party are in physical proximity to each other. If that is the case, the verifier creates a new license associated with said content item as well as with the second party. To do so, the verifier decrypts the received encrypted content license and associates the clear text license with the second party. In practice, the association is created by encrypting the clear text license by means of a public key of the second party. Consequently, only the second party is able to decrypt the created second license. In case the first license is converted into the second license the conversion not only creates the second license but also revokes the first license.

Alternatively, instead of converting the license associated with the first party into a license associated with the second party, the proximity verifier may create a license associated with the second party and revoke the license associated with the first party. In any case, the first party no longer has access to a license for the content item. As a result the content item can no longer be gifted to a further party by the first party, without first reacquiring the same, or another license.

Advantageously, the present invention determines whether the parties involved in the transaction of a content item license is in proximity of each other, as is the case when exchanging content items stored on a physical media such as a CD or a DVD. Further, unrestrained redistribution of a content item is prevented.

In an embodiment of the present invention, authentication data is provided to the proximity verifier by presenting a physical token to the verifier. In person-based DRM systems, content items are bound to persons/individuals. In these systems, users are represented by means of unique tokens such as smart cards, mobile phones or laptops. In this particular embodiment, a user (i.e. a first party) presents the token comprising authentication data to the proximity verifier in order to redistribute a content item. The proximity verifier hence contains a reader arranged to read the token, and the user (i.e. a second party) to which the content item is to be distributed must also present her token, such that proximity is ensured. The (encrypted) content item and the associated license can be stored in many different locations, for example on the token of the user giving away the item, at the proximity verifier, on a network server, etc. As previously mentioned, the verifier must be able to decrypt the first license in order to create a second license to which the receiving user is given access. This typically implies that the first party uses a secret symmetric key to encrypt the content license before sending it to the proximity verifier. The verifier also has access to the symmetric key, such that it may decrypt the license and associated the license with the receiving user. Further, the token of the receiving user may contain an address, e.g. an IP address, to which the license (and possibly the content item) is to be delivered. It should be noted that content items can be bound to a particular authorized domain as an alternative to being bound to a user.

In another embodiment of the present invention, particularly so in person-based DRM systems the authentication data may result from a biometric authentication, e.g. a person's fingerprint. This embodiment is particularly favorable in that it ties content to an actual user; it is no longer possible to impersonate a person by abusing their unique token.

In another embodiment of the present invention, which advantageously may be employed in device-based DRM systems, the proximity verifier is part of a device held by the first party. In device-based systems, users are represented by means of a device, e.g. a mobile phone. In case a mobile phone is used, the user may be authenticated by means of a unique subscriber identity module (SIM) card. Since the proximity verifier is part of the first party device, the content license may be encrypted with a public key of the first party and decrypted by the verifier with the corresponding private key. If the second party, to which a content item is to be distributed, also is represented by a mobile phone, proximity of the first and second party may be ensured by means of communicating via the infrared ports of the mobile phones. Before a second license is sent to the second party, the proximity verifier of the mobile phone of the first party typically encrypts the second license with a public key of the device of the second party, such that only the mobile phone of the second party is able to decrypt the second license and thus attain access to the cryptographic key contained therein and to subsequently decrypt the protected content item.

The present invention may advantageously be implemented in any appropriate field involving DRM protected content items, for example in consumer electronic devices such as DVD players and recorders, Streamium™ devices, TV sets, set-top boxes mobile phones, PCs, etc.

Further features of, and advantages with, the present invention will become apparent when studying the appended claims and the following description. Those skilled in the art realize that different features of the present invention can be combined to create embodiments other than those described in the following.

A detailed description of preferred embodiments of the present invention will be given in the following with reference made to the accompanying drawings, in which:

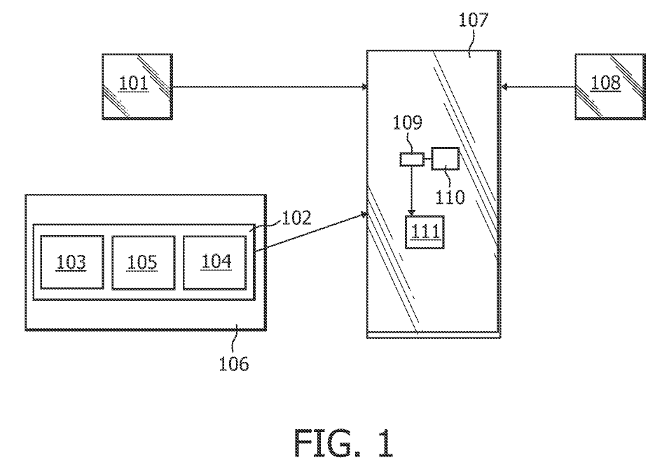

FIG. 1 shows provision of a party with a content item license in accordance with an embodiment of the present invention.

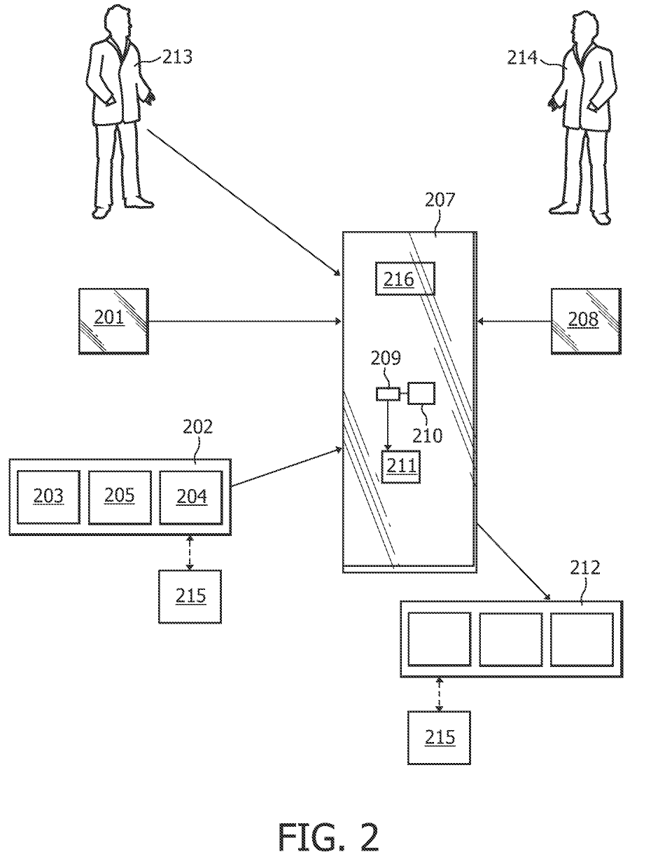

FIG. 2 shows provision of a party with a content item license in accordance with another embodiment of the present invention, which advantageously may be implemented in a person-based DRM system.

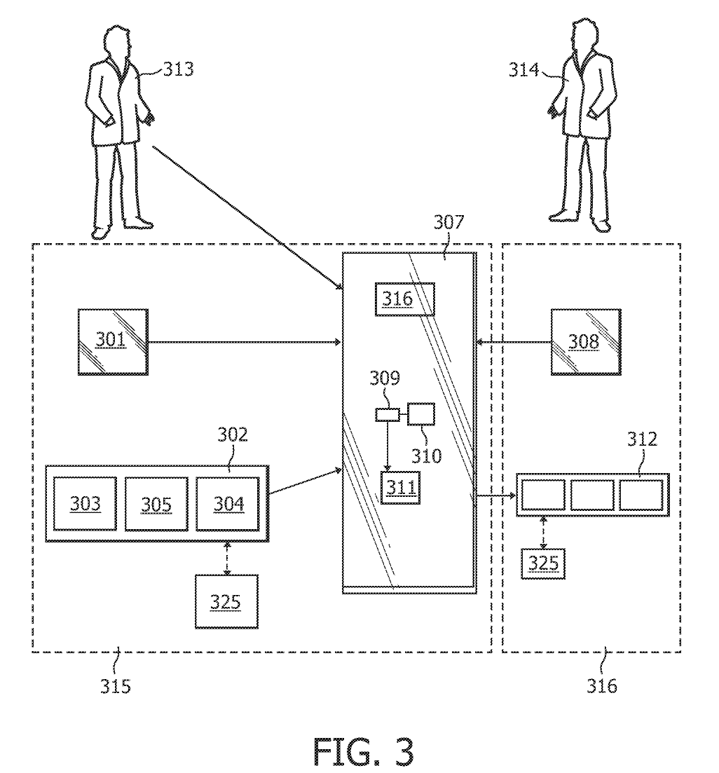

FIG. 3 shows provision of a party with a content item license in accordance with yet another embodiment of the present invention, which advantageously may be implemented in a device-based DRM system.

An embodiment of the present invention for providing a party with a content item license is illustrated in FIG. 1. A first entity 101 is in possession of a content license 102 for a particular content item (not shown). The first entity may comprise a consumer electronics (CE) device, such as a laptop, a mobile phone, a DVD player, a set-top box, etc. The first entity is either provided with a unique identifier or a token reader for reading a token presented to the device, such as e.g. a smart card or a SIM card, via which the device is provided with a unique identifier. Alternatively, the CE device is provided with an interface via which a user may provide a user ID and/or a password. In another example, the entity 101 is embodied in the form of a token such as a smart card. The license is typically associated with the first entity and the content item by a first entity identifier 103 and a content item identifier 104 comprised in the license. Further, the license generally contains usage rules 105 such as e.g. play, copy, distribute etc, indicating which type of access a party in possession of the license 102 has to the content item. As previously mentioned, the content license is in practice cryptographically protected with a public key of the party with which it is associated. Hence, only the party with which the license is associated can create a clear text copy of the license, by means of using a corresponding private key to decrypt the encrypted license. In DRM systems, to prevent unrestrained distribution of content items, the content items are encrypted and the license associated with an encrypted content item contains a content item decryption key. Consequently, the content item decryption key (not shown) can only be attained by a party having access to the private key that provides access to a plain text copy of the license. As is illustrated in FIG. 1, the content license is physically contained in a license store 106. Since the content license is cryptographically protected, the license store can be physically located just about anywhere in the world. For instance, it may be located in the entity 101 itself or in a proximity verifier 107 with which the entity communicates, as will be described in the following. In another example, it may be located on a server with which communication is enabled by means of the Internet or some other appropriate network, or possibly even stored on a token presented to the first entity 101.

When the first entity 101 wishes to give away the content item to a second entity 108, the proximity verifier 107 is provided with authentication data of the first entity. Giving away/redistributing a content item in practice implies that the protected content item license 102 and possibly the content item itself is given away; in many applications, the content item itself is stored at a content provider or at some central storage such as the proximity verifier 107, wherein a party having access to a valid content item license (and in particular the decryption key contained therein) is given access to the content item. The proximity verifier requests the second entity 108 to present its authentication data and determines whether the first and second entity 101, 108 are in physical proximity to each other. If the first and second entity each are arranged with an infrared (IR) port, IR beams may be used to prove that the entities are in physical proximity to each other. If both the first entity and the second entity are implemented as smart cards, the proximity verifier may comprise a card reader (not shown) in which the smart cards may be inserted. If the smart cards have been inserted in the proximity verifier, either both of them simultaneously or one card first and the other within a set time period, the entities must have been in physical proximity to each other.

Proximity is a relative term, the present invention uses proximity verification as a means to restrict the redistribution of content. Preferably proximity verification involves establishing a proximity measure, e.g. a proximity measure indicative of the distance between the first and the second party, or alternatively a proximity measure indicative of the sum of the distances of the proximity verifier and the respective parties. As the goal of the present invention is to restrict redistribution, proximity verification preferably translates into verifying that the first and the second party are within a maximum proximity measure value.

In one embodiment the proximity measure may be defined in terms of physical distance. Here the maximum/threshold value may be set to an arbitrary distance such as 5, 15, 25 meters, or in a more functional manner, e.g. the range of a cell of a cellular network such as GSM, the range of two communicating BT devices, or the range of two communicating wireless LAN devices. In another embodiment the proximity measure may be expressed in terms of time, a technique commonly used in digital networks. A maximum communication time may be used e.g. to restricting communications over a communications network. E.g. the threshold/maximum proximity measure value may be set to e.g. 5 ms, allowing devices that can communicate messages within a pre-determined time such as 5 ms to redistribute content. In best-effort networks such thresholds are generally chosen in a more liberal manner and instead of a plain threshold a threshold with tolerances may be used. Alternatively proof that one communication out a series of communications meets the requirement may also be accepted as a sufficient proof of proximity.

An example of using a time-based proximity measure for determining proximity between entities is the method disclosed in the applicant's own WO2004/014037 (Attorney Docket PHNL020681), which is incorporated herein by reference. In the method of WO2004/014037, a first entity performs authenticated distance measurement between said first entity and a second entity based on a shared common secret. Because the common secret is used for performing the distance measurement, it can be ensured that a distance between the correct entities is measured. The authenticated distance measurement is performed by transmitting a first signal from the first entity to the second entity at a first time t1, wherein the second entity generates a second signal by modifying the received first signal according to the common secret and transmitting the second signal to the first entity. The first entity receives the second signal at a second time t2 and checks whether the second signal has been modified according to the common secret. Finally, the distance between the first and the second entity may be determined according to a time difference between t1 and t2. Proximity may thus be determined by establishing a proximity estimate based on response time, i.e. based on the time difference. It is further possible to establish a communication channel between (a) the proximity verifier and the first entity and (b) the proximity verifier and the second entity, and thus determine the difference between the proximity verifier and the first entity and the proximity verifier and the second entity, respectively.

The above approach for proximity determination is particularly advantageous in that it may utilize the communication channel used for communications between a device according to the present invention and the first party and the second party. During the exchange of the authentication data the device could further perform a proximity determination according to the above approach with the first and the second party respectively, by using the same communication channels used for the authentication data. As a result this embodiment may be particularly efficient from a hardware point of view. Note that the above is not limited to this particular method of proximity determination, other methods of proximity determinations using communicating channels may be advantageously combined with the present invention.

Yet another approach of securely determining proximity between a first entity and a second entity involves authentication of the first and the second entity at the proximity verifier, a request for a measure of absolute position (e.g. GPS coordinates, GSM cell, etc.) from the respective entity and a check that the two entities are in proximity to each other.

It should be noted that it is not necessary that a communication channel is used for proximity determination, other means such as GPS and/or terrestrial positioning systems may be used for proximity determination.

Still another approach of determining proximity comprises biometric authentication/identification of both parties using a single entity (i.e. device/token), optionally simultaneously. This particular manner of proximity determination actually proves that both parties are in physical proximity to the single entity, and thereby to each other, rather than that their entities (i.e. their devices/tokens) are within, e.g. a predetermined physical proximity.

The proximity verifier 107 comprises one or more microprocessors 109 or some other device with computing capabilities, e.g. an application specific integrated circuit (ASIC), a field programmable gate array (FPGA), a complex programmable logic device (CPLD), etc., in order to perform processing operations such as e.g. communication, smart card data extraction or encryption/decryption. When performing steps of different embodiments of the method of the present invention, the microprocessors typically execute appropriate software that is downloaded to the proximity verifier and stored in a suitable storage area 110, such as e.g. a RAM, a Flash memory or a hard disk.

Now, a functional unit referred to as a license transformer 111 is ensured by the microprocessor 109 that the entities 101, 108 are in proximity to each other. It should be noted that even though the license transformer 111 is shown in FIG. 1 to be comprised in the proximity verifier 107, it may very well be located external to the proximity verifier, for instance on a server with which the proximity verifier is able to communicate. In case the license transformer is arranged within the proximity verifier, it is typically embodied by microprocessor 109. The encrypted content license 102 is then transferred from the license store 106 to the license transformer 111, which creates a new license associated with the content item as well as with the second entity 108. Possibly, the license storage is arranged within the proximity verifier and is embodied by memory 110. In case the embodiment of the present invention illustrated in FIG. 1 is implemented in a home environment, the proximity verifier may be embodied in the form of a computer in which the license store and the license transformer is included, and the entities 101 and 108 may be embodied in the form of a solid-state memory (comprising licenses and content item) which are inserted into a reader of the computer. To create a new license, the license transformer 111 decrypts the received encrypted content license and associates the clear text license with the second entity 108. In practice, the association is created by encrypting the clear text license by means of a public key of the second entity. Thereafter, the new license may be transferred to the second entity. A number of alternatives for providing the second entity with the new license are possible; for example, the proximity verifier transfers the new license to the second entity, or the new license is stored in a central license repository and the second entity retrieves it at the repository. Further, the new license may be sent from the proximity verifier to the first entity, which transfers it to the second entity.

In another embodiment of the present invention, the first and second entities are represented by authorized domains (ADs). In an AD, a domain policy prevails, i.e. rules governing the domain composition such as device domain membership must be complied with. Hence, in a DRM environment supporting an AD concept, the domain policy is complied with and content items such as movies, digital books and audio files, which are brought into the AD, are accessible from a limited number of compliant devices which are part of the AD. Hence, the domain policy may be that a maximum number N of compliant devices are allowed in the domain. Compliant devices are devices that are trusted and adhere to the general AD/DRM compliance rules. If a content item license is to be transferred from one AD to another, the license should, in analogy with the illustration of FIG. 1, be unbound from a first AD and coupled to a second AD.

Various proposals exist that implement the concept of ADs to some extent. In so-called device based ADs, the domain is formed by a specific set of hardware devices or software applications (referred to collectively as clients hereafter) and content. A domain manager, which can be one or more of the clients, a smart card or another device, controls which clients may join the domain. Only the specific set of clients in the domain (the members) is allowed to make use of the content of that domain, e.g. to open, copy, play or export it. Examples of such device-based ADs are given in international patent application WO 03/098931 (attorney docket PHNL020455), international patent application WO 05/088896 (attorney docket PHNL040288) and international patent application WO 04/027588 (attorney docket PHNL030283) by the same applicant, all of which are hereby incorporated by reference.

One type of device-based AD allows a set of clients bound to a domain to access content bound to that domain. This double binding assures that all the members can access the content. This structure is often established by implementing the bindings through a shared secret key. This key is chosen by a domain manager and distributed to all the members. When content is bound to the domain, the license is cryptographically linked to the domain by means of encryption with the shared key. Alternatively the content may be directly bound to one client, and the clients remain bound to the AD.

Another type of AD is the so-called person-based AD, where the domain is based on persons instead of devices. An example of such a system is described in international patent application WO 04/038568 (attorney docket PHNL021063) by the same applicant, incorporated herein by reference, in which content is coupled to persons, which then are grouped into a domain.

A so-called Hybrid Authorized Domain-based DRM system ties content to a group that may contain devices and persons. Examples of hybrid AD systems can be found in international patent application WO 2005/010879 (attorney docket PHNL030926) and in international patent application WO 2005/093544 (attorney docket PHNL040315), both incorporated herein by reference.

In another embodiment of the present invention, which advantageously may be implemented in DRM systems as defined by the Open Mobile Alliance (OMA), a first entity 101 provides a second entity 108 with authentication data and states that it wishes to give away a content item license. The second entity 108 then determines whether the first and second entities are in physical proximity to each other (e.g. by using IR beams), and requests a rights issuer 107 to create a new license in line with the previously described embodiment of FIG. 1. The rights issuer 107 authenticates both entities 101, 108 and checks validity of proximity assurance. If the entities are (i) authenticated and (ii) in proximity to each other, a new license is created.

A further embodiment of the present invention for providing a party with a content item license is illustrated in FIG. 2, which advantageously may be implemented in a person-based DRM system. A first user 213 is in possession of a content item license 202 for a particular content item 215. The first user 213 has access to a token in the form of a smart card 201 comprising a user identifier smart card. The license is typically associated with the first user and the content item by a first user identifier 203 and a content item identifier 204 comprised in the license. Further, the license contains usage rules 205. As previously mentioned, the content license is cryptographically protected with a public key of the party with which it is associated. A proximity verifier 207 stores the content item license 202 in a memory 210 and contains an interface 216 such as a browser via which the first user 213 may select the license (and possibly the content item 215) to be given away to a second user 214. Then the user 213 presents his token 201 to the proximity verifier 207 and provides the verifier with authentication data of the user. The proximity verifier 207 requests the second user 214 to provide his authentication data by means of a second token 208, and determines whether the first and second users 213, 214 are in physical proximity to each other.

Now, a license transformer 211 is ensured by a microprocessor 209 that the users 213, 214 are in proximity to each other. The encrypted content license 202 is then transferred from the memory 210 to the license transformer 211, which creates a new license 212 associated with the content item 215 as well as with the second user 214. To create a new license, the license transformer 211 decrypts the encrypted content license 202 and associates the clear text license with the second user 214. In practice, the association is created by encrypting the clear text license by means of a public key of the second user. Thereafter, the new license 212 may be transferred to the second user 214, or possibly to his token 208. Typically, the new license 212 further contains usage rules similar to the old content item license 202.

Yet another embodiment of the present invention for providing a party with a content item license is illustrated in FIG. 3, which advantageously may be implemented in a device-based DRM system. In this embodiment, a proximity verifier 307 is part of a device 315 held by a first user 313. In device-based systems, users are represented by means of a device, e.g. a mobile phone. In case mobile phones 315, 316 are used, each user 313, 314 may be authenticated by means of a unique subscriber identity module (SIM) card 301, 308. Since the proximity verifier 307 is part of the device of the first user, the content license may be encrypted with a public key of the first user and decrypted by the verifier with the corresponding private key. The first user 313 is in possession of a content item license 302 for a particular content item 315. The license is associated with the first user and the content item by a first user identifier 303 and a content item identifier 304 comprised in the license. Further, the license contains usage rules 305. The proximity verifier 307 stores the content item license 302 in a memory 310. The first user 313 selects, via an interface 316, the content license to be given away to the second user 314. The proximity verifier 307 requests the second user 314 to provide his authentication data held by the SIM card 308 of the device 316, and determines whether the first and second devices 315, 316 are in physical proximity to each other. Then, a license transformer 311 is ensured by a microprocessor 309 that the devices 315, 316 are in proximity to each other. The encrypted content license 302 is then transferred from the memory 310 to the license transformer 311, which creates a new license 312 associated with the content item 315 as well as with the second device 316. To create a new license, the license transformer 311 decrypts the encrypted content license 302 and associates the clear text license with the second user 314. In practice, the association is created by encrypting the clear text license by means of a public key of the second user. Thereafter, the new license 312 may be transferred to the device 316.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of providing a party with a content item license (202), said method comprising the steps of:
receiving authentication data of a first party (213) and a second party (214);
receiving a license (202) associated with a content item (215) and the first party;
determining whether the first party and the second party are in physical proximity to each other;
creating a license (212) associated with said content item (215) and the second party (214), if the parties are in physical proximity to each other, said license giving the second party access to said content item; and
revoking the license (202) associated with the first party (213).

2. The method according to claim 1, wherein authentication data of at least one of the parties (213, 214) is received from a token (201, 208) associated with said at least one party.

3. The method according to claim 1, wherein the step of creating a license (212) associated with the second party (214) comprises:
converting the license (202) associated with the first party (213) into a license (212) associated with the second party (214).

4. The method according to claim 1, wherein the step of creating a license (212) associated with the second party (214) comprises:
encrypting the license (212) with a cryptographic key of the second party (214).

5. The method according to claim 1, further comprising the step of:
transferring, to the second party (214), the content item (215) and the license (212) associated with the content item and the second party.

6. The method according to claim 1, wherein said first party (213) and said second party (214) are represented by one of:
users,
devices (201, 208), and
authorized domains.

7. The method according to claim 1, wherein the step of creating a license (212) associated with the second party (214) comprises:
authenticating a license storage (106) where said license (102) associated with the first party (213) is stored;
transferring said license associated with the first party from said license storage to a license transformer (111); and
associating the license with said second party instead of said first party, wherein said license associated with the second party is created.

8. The method according to claim 1, wherein the step of determining whether the first party (213) and the second party (214) are in physical proximity to each other comprises the step of:
attaining a proximity estimate by establishing a response time of a communication over a communication channel involving the first and the second party.

9. The method according to claim 1, wherein the step of determining whether the first party (213) and the second party (214) are in physical proximity to each other comprises the step of:
determining respective physical positions of the first party and the second party.

10. A device (207) for providing a party with a content item license, said device comprising:
deriving means (209) for deriving authentication data of a first party (213) and a second party (214);
receiving means (209) for receiving a license (202) associated with a content item (215) and the first party;
determining means (209) for determining whether the first party and the second party are in physical proximity to each other;
creating means (211) for creating a license (212) associated with said content item and the second party, if the parties are in physical proximity to each other, said license giving the second party access to said content item; and
revoking means (211) for revoking the license (202) associated with the first party.

11. The device (207) according to claim 10, wherein the creating means (211) is arranged to send said license (202) associated with a content item (215) and the first party (213) to an external license transformer device and receiving said license (212) associated with said content item (215) and the second party (214) from the external license transformer device.

12. The device (207) according to claim 10, wherein said deriving means comprises:
a reader for reading a token (201, 208) of the respective party (213, 214).

13. The device (207) according to claim 10, further comprising:
a user interface (216) with which the first party (213) selects the license (202) associated with a content item (215) and the first party.

14. The device (207) according to claim 13, said user interface (216) further being arranged such that the first party (213) selects the content item (215) with which the license (202) is associated.

15. The device (207) according to claim 10, wherein the means for creating a license (212) associated with the second party (214) further is arranged to encrypt the license with a cryptographic key of the second party.

16. The device (307) according to claim 10, said device being included with a consumer electronics device (315) to which said first party (313) has access.

17. The device according to claim 10, further comprising a consumer electronics device (315) identity reader for deriving identity of a proximate consumer electronics device (316).

18. A system for providing a party with a content item license, said system comprising at least two devices according to claim 10.

19. A computer program product comprising computer-executable components for causing a device (107, 207, 307) to perform the steps recited in claim 1 when the computer-executable components are run on a processing unit (109, 209, 309) included in the device.
